(19) United States
(12) Patent Application Publication
(10) Pub. No.: US 2005/0226465 A1
(43) Pub. Date: Oct. 13, 2005

(54) Seed fragment inspection apparatus

(75) Inventors: Kazuo Fujita, Hiroshima (JP); Ichiro Honda, Tokyo (JP); Katumi Yoshinaga, Hiroshima (JP)

Correspondence Address: Christopher J. Fildes;Fildes & Outland, P.C., 20916 Mack Avenue, Suite 2, Grosse Pointe Woods, MI, 48236, US

(73) Assignee: Nichizo Iron Works & Marine Corporation. Shoei Foods Corporation, and Aio. , Ltd.

(21) Appl. No.: 10/970,200

(22) Filed: Oct. 21, 2004

(30) Foreign Application Priority Data
Apr. 9, 2004 (JP) 2004-114835

(51) Int. Cl. G06K 9/00

(52) U.S. Cl. 382/110

(57) ABSTRACT

Infrared cameras (51, 54) and infrared illuminators (53, 55) thereof are opposed to each other across a transparent belt (41a). The infrared cameras (51, 54) photograph the front sides and the backsides of pitted fruits (prunes) which are conveyed by a conveyor (41) of the transparent belt (41a). A region of the fruit at a predetermined level or lower is determined based on the photographing data of the infrared cameras (51, 54), an average brightness level on the edge surface of the fruit region is determined, a depressed portion at a predetermined level or lower is determined based on the determined average brightness level, and it is decided whether a seed fragment remains in the fruit based on the shape of the depressed portion that is a characteristic of a measurable brightness level (shade) property.

### FIELD OF THE INVENTION

The present invention relates to a seed fragment inspection apparatus for inspecting whether a seed fragment remains in a fruit such as a prune having been pitted by a pitting device or the like.

### BACKGROUND OF THE INVENTION

Conventionally, pitted fruits (e.g., pitted prunes) are produced by forcibly pitting seeds by means of a pitting device.

In the operation of pitting fruits, there is a probability that a seed may not be removed or a seed fragment may remain. Thus, for each fruit, it is inspected whether a seed or a seed fragment remains after pitting.

As an inspecting method, the following is available: an image of a fruit is captured by a camera while the fruit is illuminated, a threshold value is set for the contrast level of the image, and when an image region lower (darker) than the threshold value is detected, it is decided that a seed or a seed fragment remains.

Japanese Patent Laid-Open No. 2002-316099 discloses an inspection apparatus for deciding the presence or absence of a seed or a seed fragment in a fruit in the same manner as the above inspecting method.

This inspection apparatus relates to an apparatus for inspecting whether a gel-coated seed remains, and comprises a camera for photographing a gel-coated seed, an illuminator, and a discriminating device for checking the quality of a seed. The camera and the illuminator are opposed to each other across a conveying device of a gel-coated seed, a transmitted image of a gel-coated seed is photographed by the camera, image processing is performed by the discriminating device, and it is inspected whether one seed is contained in each gel. In the image processing, the gel of the gel-coated seed is recognized and a shadow area of the seed in the gel is calculated. When the shadow area is within a set range, it is recognized that a seed is present. When the shadow area is equal to or smaller than the set range, it is recognized that a seed is absent.

However, in the configuration of the foregoing known inspection apparatus, when a wrinkle appears on the surface of a gel-coated seed, the range of the wrinkle is recognized as a seed. Thus, by merely recognizing a detected area, it is not possible to distinguish whether a seed is actually present or not.

In the foregoing conventional inspecting method, an image of a fruit is captured by the camera while the fruit is illuminated, a threshold value is set for the contrast level of the image, and when an image region lower (darker) than the threshold value is detected, it is decided whether a seed or a seed fragment remains. In this method, when the surface of a seed has many wrinkles, the following problem arises.

When the threshold value is set at which wrinkles are recognized, the wrinkles are determined as a seed and it is decided that a seed or a seed fragment remains, and a large amount of good articles are removed and lost. Further, when the threshold value is set so as not to recognize wrinkles, a small seed fragment cannot be detected.

### DISCLOSURE OF THE INVENTION

An object of the present invention is to provide a seed fragment inspection apparatus which can distinguish between a small seed fragment and a wrinkle and achieve high-quality pitted fruits with high yields.

In order to attain the object, The seed fragment inspection apparatus of the present invention comprises a transparent belt conveyor for conveying a pitted fruit, illuminators which are opposed to each other across the transparent belt of the transparent belt conveyor and emits a transmission light beam to the fruit conveyed by the transparent belt conveyor, the light beam passing through the fruit, a camera device for photographing an image of the transmission light beam having been emitted from the illuminators and passed through the fruit, and a controller which determines a region at a predetermined brightness level (R) or lower as a fruit region based on the photographing d+at a of the camera device, determines an average brightness level of an edge surface of the fruit region, determines a region at a predetermined level (S) or lower as a region of a depressed portion based on the determined average brightness level, and decides whether or not a seed fragment remains in the fruit based on the shape of the determined depressed portion.

With this configuration, an average brightness level of the edge surface of the fruit is determined, that is, an average brightness level of the specified surface identified as a wrinkle portion having no seed fragment. A region at or lower than the level (S) determined based on this average brightness level, that is, a depressed portion which may have a seed fragment is determined. Based on the shape of this depressed portion (a characteristic of a measurable brightness level/shade property), a distinction is made between a wrinkle on the surface of the fruit and a seed fragment. Hence, it is possible to prevent a number of comforting articles from being removed and lost by mistaking wrinkles for seed fragments, thereby to obtain high-quality pitted fruits with high yields.

### BRIEF DESCRIPTION OF THE DRAWINGS

FIG. 1 is a plan view showing a seed fragment inspection apparatus according to an embodiment of the present invention;

FIG. 2 is a side view showing the seed fragment inspection apparatus;

FIG. 3 is a structural diagram showing the seed fragment inspection apparatus;

FIG. 4 is a structural diagram showing a rolling device of a rolling section of the seed fragment inspection apparatus;

FIG. 5 is a structural diagram showing an inspection/image processing/selection section of the seed fragment inspection apparatus;

FIG. 6 is a diagram showing a state of photographing prunes in the inspection/image processing/selection section of the seed fragment inspection apparatus;

FIG. 7 is a structural diagram showing an operation/control/power section of the seed fragment inspection apparatus;

FIG. 8 is a control structural diagram showing the inspection/image processing/selection section of the seed fragment inspection apparatus;

FIGS. 9A, 9B and 9C each is an explanatory diagram showing the image processing of the seed fragment inspection apparatus;

FIG. 10 is a characteristic diagram showing the image processing of the seed fragment inspection apparatus;

FIG. 11 is a flowchart showing the image processing of the seed fragment inspection apparatus; and

FIGS. 12A, 12B and 12C each is an explanatory diagram showing the image processing of the seed fragment inspection apparatus.

### DESCRIPTION OF THE EMBODIMENTS

An embodiment of the present invention will be described below in accordance with the accompanying drawings.

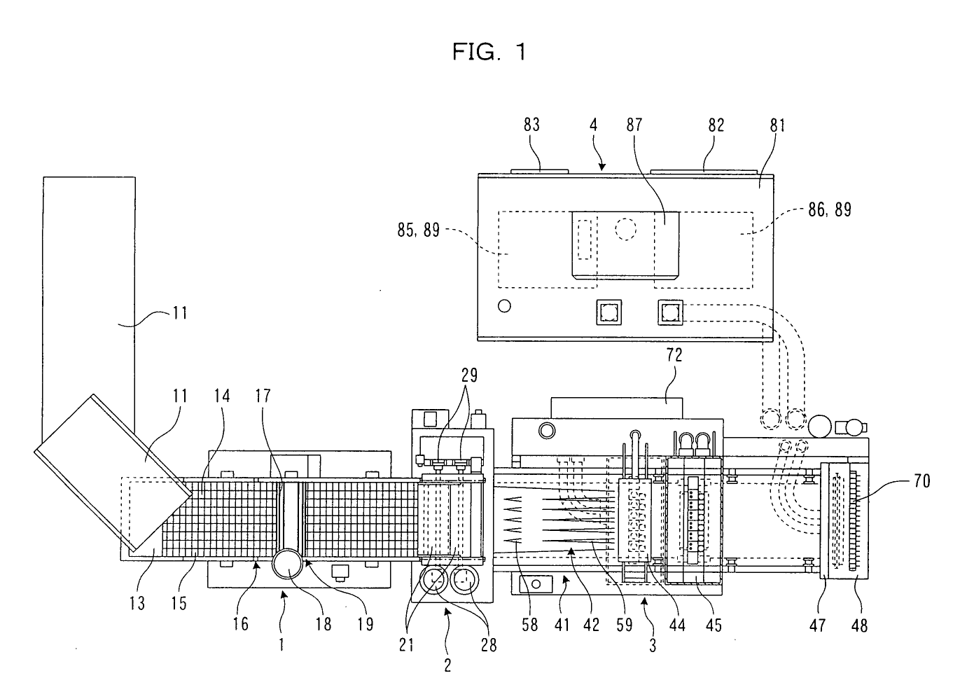

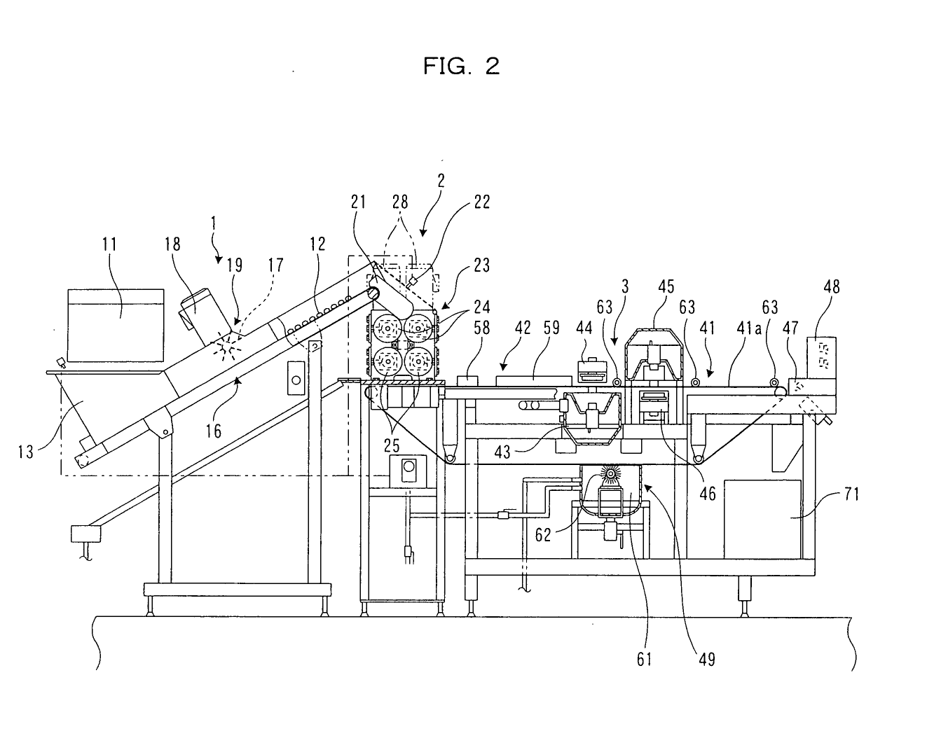

FIG. 1 is a plan view showing a seed fragment inspection apparatus according to the embodiment of the present invention. FIG. 2 is a side view showing the seed fragment inspection apparatus.

The seed fragment inspection apparatus is mainly constituted of a supply section 1, a rolling section 2, an inspection/image processing/selection section 3, and an operation/control/power section 4.

[Supply Section 1]

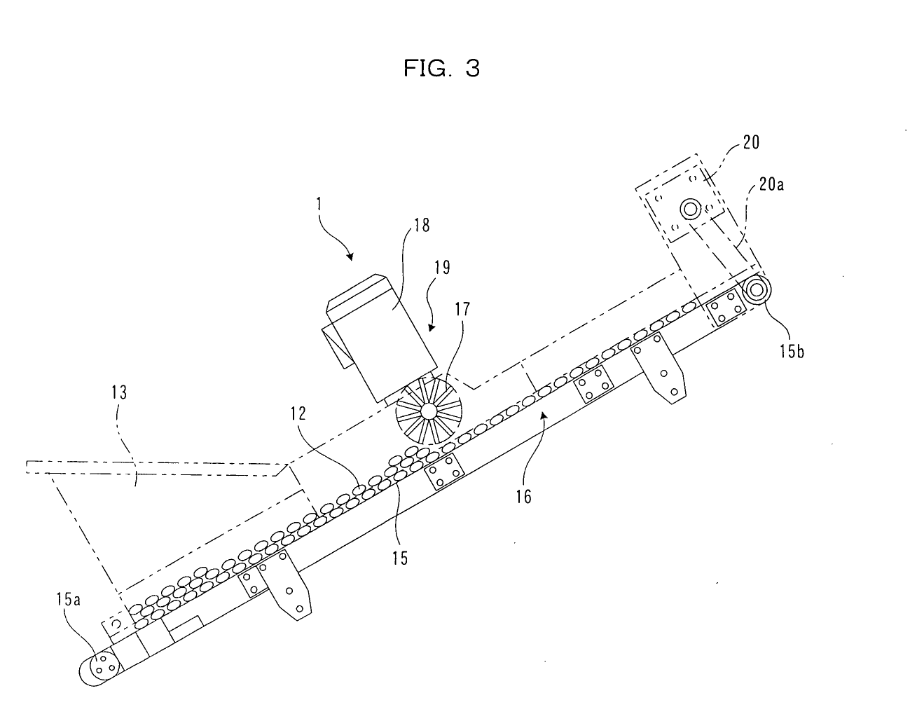

As shown in FIGS. 1 to 3, the supply section 1 is constituted of a hopper 13, in which prunes (an example of a fruit, hereinafter simply referred to as prunes) 12 having been pitted and conveyed from an external conveyer 11 are dropped, a leveling conveyor 16 which receives the prunes 12 having been supplied into the hopper 13 at random and conveys the prunes 12, and a leveling roller 19 which is disposed almost at the center of the leveling conveyor 16 and arranges and conveys each of the prunes 12 without overlapping. The prunes 12 have stickiness, and many of the prunes 12 are compressed and become sticky during a long storage in a tank. Further, stickiness increases due to pulp squeezed out during a pitting operation and thus the plurality of sticky prunes 12 are supplied in many cases. Thus, the leveling roller 19 is provided to eliminate the stickiness and prevent the prunes 12 from overlapping each other.

The leveling conveyor 16 is configured so that a conveyor 15 is tilted at 40° so as to convey the prunes 12 obliquely upward. The conveyor 15 has a crosspiece in the conveying direction of the prunes 12 and has rectangular squares 14 in nine lines that are divided in the width direction by polymeric resin guide bars inserted in grooves which are formed by cutting in the width direction of the crosspiece. Further, the conveyor 15 is provided in a tensioned state over a driven roller 15a and a driving roller 15b on which the front and rear ends of the leveling conveyor 16 are disposed. A driving motor 20 is provided to drive the driving roller 15b via a belt 20a. With this configuration, the prunes 12 supplied into the hopper 13 at random during operation are received by the conveyor 15 and are conveyed obliquely upward at 40° by the conveyor 15.

The leveling roller 19 is disposed almost at the midpoint of the leveling conveyor 16 and rotates opposite to the direction of conveying the prunes 12 on the conveyor 15. The leveling roller 19 is constituted of rotary vanes 17 for properly striking the overlapping prunes 12 when the prunes 12 are conveyed by the conveyor 15, and a driving motor 18 for driving the rotary vanes 17. With this configuration, the overlapping prunes 12 having been conveyed obliquely upward at 40° by the conveyor 15 are readily scraped down by the rotary vanes 17, the prunes 12 are respectively stored in the squares 14, and thus the prunes 12 can be neatly conveyed without overlapping.

According to the configuration of the supply section 1, the prunes 12 having been conveyed by the external conveyer 11 are respectively stored in the squares 14 of the conveyor 15 of the leveling conveyor 16 and are neatly conveyed without overlapping. The neatly conveyed prunes 12 are supplied to the rolling section 2 (rolling device) by dropping.

[Rolling Section 2]

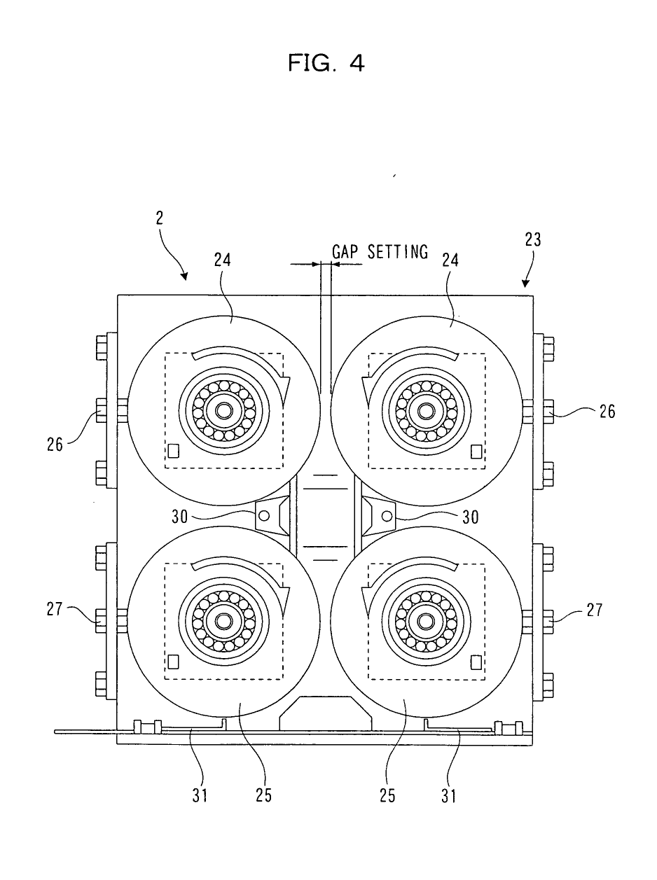

As shown in FIGS. 1, 2, and 4, the rolling section 2 has an alignment fin which is disposed at the entrance and corresponds to the supply lines (nine lines) of the leveling conveyor 16. The rolling section 2 is constituted of a dividing guide plate 21 which slides the prunes 12 in nine lines after the prunes 12 are supplied by dropping from the leveling conveyor 16 of the supply part 1, a spray nozzle 22 which is disposed almost above the midpoint of the dividing guide plate 21 and sprays water to pressure rollers and scrapers (described later) via the dividing guide plate 21, and a rolling device 23 which rolls the prunes 12 vertically dropped in nine lines from the dividing guide plate 21 so that a transmission light beam (described later) evenly passes through the prunes 12, and cuts the visible outline of a wrinkle to discriminate between the wrinkle on the prune 12 and a fragment of a seed (hereinafter referred to as a seed fragment).

The rolling device 23 is configured so that two opposing pairs of rolling rollers 24 and 25 are disposed vertically in two stages. Gap adjusting screws 26 and 27 are provided to adjust a gap between the pair of the upper rollers 24 in the first stage and a gap between the pair of lower rollers 25 in the second stage, respectively. The thickness of the prune 12 is determined by adjusting the gap adjusting screws 26 and 27. Further, the rotation axes of the pair of the upper rollers 24 have ends respectively connected to driving motors 28, and a V belt 29 is provided in a tensioned state over the other ends of the pair of the upper rollers 24 and the rotation axes of the pair of the lower rollers 25. The rollers 24 and 25 are both driven rotationally by the driving of the driving motors 28.

Moreover, scrapers 30 and 31 are provided respectively under the upper rollers 24 and the lower rollers 25 to successively exfoliate the sticky prunes 12, on which pulp is exposed, from the surfaces of the rollers and scrape sticky materials of the prunes 12.

Groove processing has been performed on the surfaces of the rollers 24 and 25 vertically and horizontally. Rolling is performed on uneven and deep wrinkles on a skin that are the characteristic of the prunes 12 in a dry state. Thus, detected wrinkles in image processing are reduced. That is, horizontal (axial) grooves are processed on the surfaces of the pair of the upper rollers 24 to prevent the catching of the prunes 12 from being delayed by the shape (flat shape, round shape) and hardness (hard skin) of the prunes 12. Further, in order to prevent the adverse effect of wrinkles on an image, the surfaces of the pair of the lower rollers 25 have pyramidal protrusions whose tops are cut. The protrusions are displaced from each other so that the thickness of the prune 12 does not decrease too much.

The upper rollers 24 loosely perform rolling, whereas the lower rollers 25 tightly perform rolling. A rolling gap is set at a thickness enabling a transmission light beam (described later) to evenly pass through the prune 12 to accurately and stably inspect the prunes 12. Further, the rolling gap is adjusted in consideration of the moisture and return of the prune 12. For example, the rolling gap is set at 5 mm in the upper stage and the rolling gap is set at 4 mm in the lower stage. In this setting, the prune 12 has a thickness of 7 to 8 mm in the inspection/image processing/selection section 3 disposed downstream.

With the configuration of the rolling section 2, the prunes 12 are dropped into the upper rollers 24 while being aligned by the dividing guide plate 21. At this point, water is sprayed by the spray nozzle 22 disposed in the upper part. The prunes 12 are sequentially rolled by the upper rollers 24 and the lower rollers 25 with even thicknesses so as to form the transmitting conditions of a transmission light beam (described later), the visible outlines of wrinkles on the prunes 12 are cut, and the prunes 12 are dropped to a belt conveyor 41 of the inspection/image processing/selection section 3.

[Inspection/Image Processing/Selection Section 3]

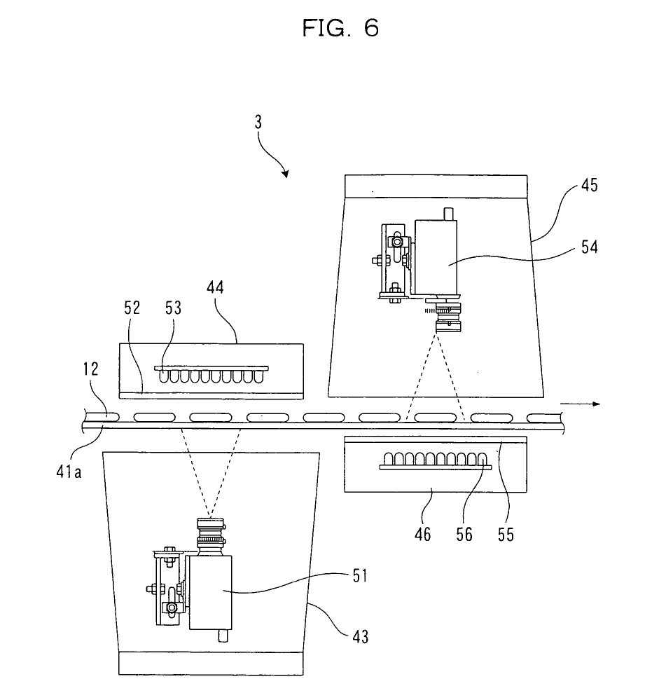

As shown in FIGS. 1, 2, 5, and 6, the inspection/image processing/selection section 3 is constituted of the belt conveyor (an unit for conveying fruits) 41 with a transparent meanderless belt configuration which receives and conveys the prunes 12 having been dropped from the rolling device 23 of the rolling section 2 while being rolled, an alignment guide 42 which is formed on a transparent belt 41a at the entrance side (upstream side) of the belt conveyor 41 and aligns the conveyed prunes 12 in six lines without overlapping, a lower camera case 43 and a lower illumination case 44 and an upper camera case 45 and an upper illumination case 46 which are disposed almost at the center of the belt conveyor 41 so as to be opposed to each other across the transparent belt 41a in order to image seeds remaining in the prunes 12 with a transmission light beam, an air ejecting selection device 47 which is disposed on the downstream end of the belt conveyor 41 and sorts the prunes 12 (removes the prunes 12 judged to be defective) by blowing air to an NG box 71, a solenoid valve case 48 for ejecting/stops air in the selection device 47, and a cleaning chamber 49 which is disposed on the return side of the transparent belt 41a under the belt conveyor 41 and always washes out pulp adhering to the surface of the transparent belt 41a.

The lower illumination case 44 comprises near-infrared LED illuminators (920 nM×1056) 53 for irradiating the front sides of the prunes 12, which are aligned in six lines and are conveyed by the transparent belt 41a, with near-infrared light (an example of a transmission light beam) from above via a white-milk diffuser panel 52. Further, the lower camera case 43 comprises six infrared CCD cameras (an example of a camera device) 51 disposed via the transparent belt 41a. From the backsides of the prunes 12, the infrared CCD cameras 51 photograph images of transmission light beams which have been emitted from the near-infrared LED illuminators 53 and passed through the prunes 12. With this configuration, near-infrared light emitted from the near-infrared LED illuminators 53 is evenly diffused into light beams through the diffuser panel 52, is emitted to the front sides of the prunes 12 which are aligned and conveyed on the transparent belt 41a, and passes through the prunes 12, so that the images of the backsides of the prunes 12 are photographed by the six infrared CCD cameras 51.

The upper illumination case 46 comprises near-infrared LED illuminators (920 nM×1056) 56 for irradiates the backsides of the prunes 12, which are aligned in six lines and are conveyed by the transparent belt 41a, with near-infrared light (an example of a transmission light beam) from below via a white-milk diffuser panel 55. Further, the upper camera case 45 comprises six infrared CCD cameras (an example of a camera device) 54 disposed via the transparent belt 41a. From the front sides of the prunes 12, the infrared CCD cameras 54 photograph images of transmission light beams which have been emitted from the near-infrared LED illuminators 56 and passed through the prunes 12. With this configuration, near-infrared light emitted from the near-infrared LED illuminators 56 is evenly diffused into light beams through the diffuser panel 55, is emitted to the backsides of the prunes 12 which are aligned and conveyed on the transparent belt 41a, and passes through the prunes 12, so that the images of the front sides of the prunes 12 are photographed by the six infrared CCD cameras 54.

The lower illumination cases 44 and 46 each comprise two cooling fans (not shown) for cooling heat generated in LED illumination. The two fans perform cooling throughout the operation.

The aligning guide 42 is divided into five guides 58 in the first stage that are extended to the vicinity of the upstream end of the belt conveyor 41 (to the vicinity of the rolling device 23) and five guides 59 in the second stage that are extended to the vicinity of the lower camera case 43. The prunes 12 are aligned in six lines so that the prunes 12 can be conveyed immediately below the six infrared CCD cameras 51 and 54 without overlapping. The guides 58 in the first stage store the dropping prunes 12 in any one of the lines. A space is made between the guides 58 in the first stage and the guides 59 in the second stage, so that the prunes 12 falling sideways like a top are fell into this space and are arranged. Further, the guides 59 in the second stage prevent the prunes 12 from deviating sideways under the six infrared CCD cameras 51, 54.

Further, the prune 12 does not always have a similar shape and the outside shape is always changed (size, curve, thickness, wrinkles). An edge is prone to darken in image processing. In the frame of image processing, an image becomes darker on the outer edge of the frame due to the relationship between the characteristic of a transmission light beam traveling in a straight line and the size of a camera lens. The aligning guide 42 conveys the prunes 12 without overlapping and reduces a dark part on the edge of the visual angle of the camera by conveying the prunes 12 immediately under the camera and capturing an image. Thus, it is possible to eliminate an excessive detection of NG (defective) on the edges of the prunes 12, which become too dark in images, and eliminate a reduction in yields.

The cleaning chamber 49 is constituted of a tank 61 filled with fresh water and a cleaning brush 62 which is always dipped into the fresh water of the tank 61 and has one end rotationally making contact with the transparent belt 41a to successively scrape and wash out the adhering pulp of the prunes 12. A small amount of fresh water is always supplied into the tank 61 and excessive water causes the water-soluble matter of the prunes 12 to overflow. Precipitates in the tank 61 can be readily cleaned by opening a door provided on the tank 61. With this configuration, the transparent belt 41a is always cleaned and kept in a clean state all the time. Therefore, images photographed by the infrared CCD cameras 51 and 54 are stabilized.

The transparent belt 41a of the belt conveyor 41 is provided in a tensioned state over a pair of upper rollers 64 at the front and back and a pair of lower rollers 65 at the front and back. The lower rollers 65 guide the transparent belt 41a on the return side to the cleaning chamber 49. Then, a driving motor 66 is connected to one end of the rotation axis of the front upper roller 64 and a rotary encoder 67 is attached to the other end of the rotation axis. The transparent belt 41a is driven by the driving of the driving motor 66 to convey the prunes 12. Further, vibration suppressing rollers 63 for suppressing vibration on the transparent belt 41a are provided on a plurality of points (three points in FIG. 2) on the transparent belt 41a.

The air ejecting selection device 47 comprises six sets of air guns 69 that correspond to the prunes 12 in six lines in order to sort out the prunes 12 by blowing the prunes 12 judged to be defective to the NG box 71 with air. The solenoid valve case 48 comprises solenoid valves 70 for ejecting/stopping air in each set of the air guns 69. The set of air guns is composed of, for example, ten air guns.

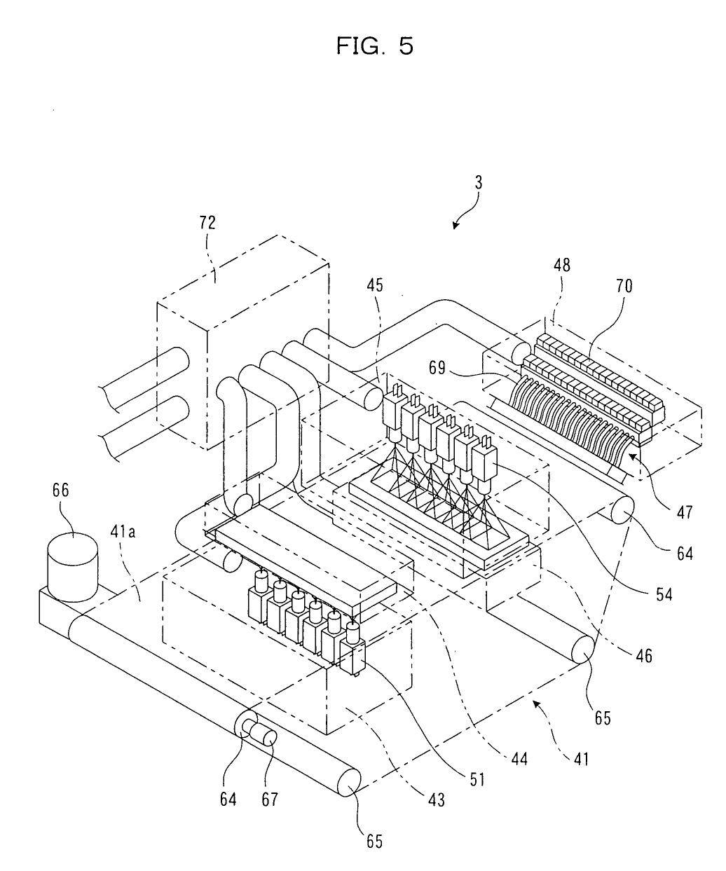

In FIGS. 1 and 5, reference numeral 72 denotes an intermediate terminal box which combines the wiring of the infrared CCD cameras 51 and 54, the near-infrared LED illuminators 53 and 56, and the solenoid valves in the solenoid valve case 48 and connects the wiring to the operation/control/power section 4.

With the configuration of the inspection/image processing/selection section 3, the prunes 12 dropped from the rolling device 23 of the rolling section 2 in a rolling state are aligned in six lines without overlapping by the aligning guide 42 while being conveyed by the belt conveyor 41. Then, almost at the center of the belt conveyor 41, the surfaces of the prunes 12 on the transparent belt 41a are irradiated with near-infrared light from the near-infrared LED illuminators 53, the near-infrared light passes through the prunes 12, and the images of the backsides of the prunes 12 are photographed by the six infrared CCD cameras 51. Subsequently, the backsides of the prunes 12 on the transparent belt 41a are irradiated with near-infrared light from the near-infrared LED illuminators 56, the near-infrared light passes through the prunes 12, and the images of the front sides of the prunes 12 are photographed by the six infrared CCD cameras 54. When a controller (described later) detects a seed fragment remaining in the prune 12, the prune 12 is blown to the NG box 71 with air and is sorted out. Further, pulp adhering to the surface of the transparent belt 41a is always washed out on the return side of the transparent belt 41a.

[Operation/Control/Power Section 4]

As shown in FIGS. 1, 2, 7, and 8, the operation/control/power section 4 is constituted of a control board body (housing) 81, device operation buttons 82 and a touch panel 83 which are disposed at the front of the control board body 81, an image processing device 84 included in the control board body 81, an inverter 85 for adjusting the speeds of the driving motors 18, 20, 28, and 66 included in the control board body 81, a power supply 86 included in the control board body 81, and an air system (cooler, heater, etc.) 87 which is disposed along with the control board body 81, automatically keeps a constant temperature in the control board body 81 all the time, and recovers a dry state even if moisture enters due to an opened door.

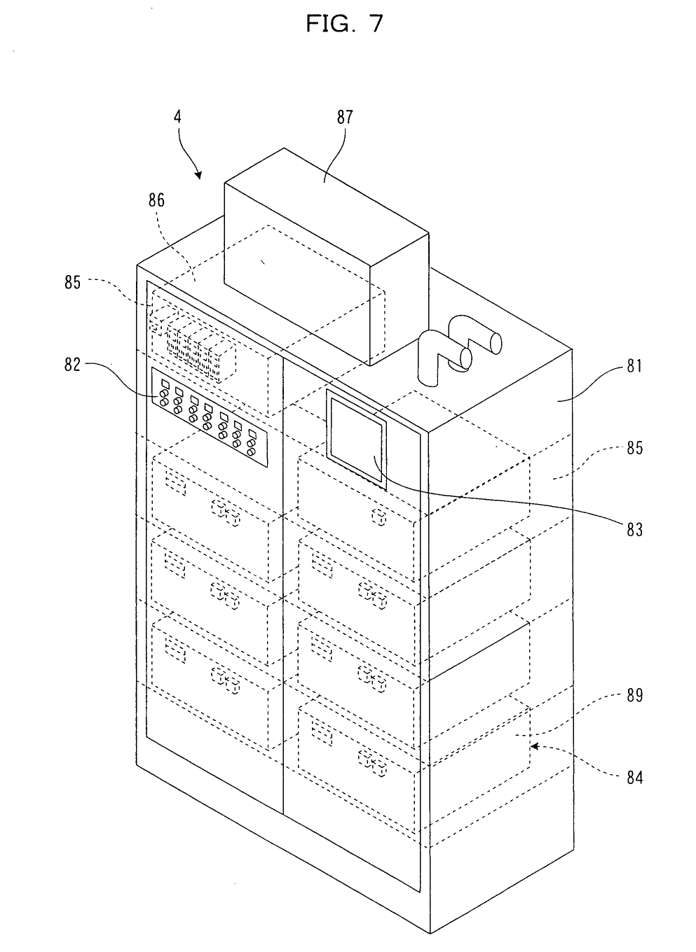

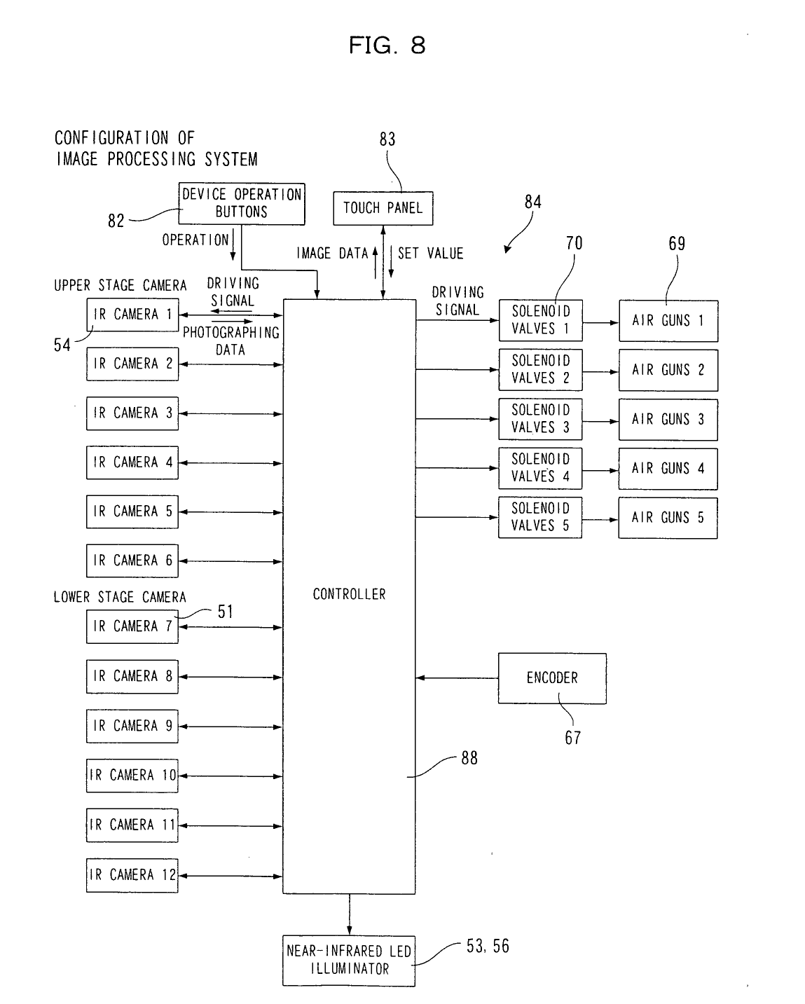

As shown in FIG. 8, the image processing device 84 is constituted of a controller 88 composed of a plurality of computers (CPU) connected to the six infrared CCD cameras 51 in the lower stage, the six infrared CCD cameras 54 in the upper stage, the near-infrared LED illuminators 53 and 56, the rotary encoder 67, the six sets of solenoid valves 70 that correspond to the six sets of air guns 69, the device operation buttons 82, and the touch panel 83. First, based on photographing data inputted from the infrared CCD cameras 51 and 54, the controller 88 decides whether the prunes 12 in each line are acceptable or not from the backsides and the front sides of the prunes 12 (the detail will be described later). When NG (defective: a seed fragment is present) is decided, the counted value of a digital position signal (pulse signal) from the rotary encoder 67 is converted into a distance between the ends of the conveyor, and a removal signal is outputted to the solenoid valves 70. Operating voltage is applied and compressed air is ejected to blow the NG prune 12 in the line to the NG box 71, so that the NG prune is removed (sorted). The operating timing of the solenoid valves 70 is set by the touch panel 83. This setting determines a time to start blowing and a time to open the solenoid valves 70, so that preferred sorting can be carried out. The controller 88 is stored in each of six control boxes 89 shown in FIG. 7.

[Image Processing]

Image processing performed by the controller 88 will be described in detail.

When near-infrared light is emitted to the prune 12 having been rolled to the thickness of 8 to 10 mm, the shadow of a seed is observed. A large seed (1/1) is readily observed as a large shadow, whereas fragments (½, ¼, ⅛, 5 square millimeters) are observed as small shadows (black depressed portions). In the case of the semidry prune 12, the skin is black and the pulp in the prune 12 largely shrinks by drying, whereas the surface has “wrinkles” because the skin shrinks less. The wrinkles become overlapping skins and are imaged as a dark wave (shade) or a shadow at a level close to a fragment of a small seed.

Further, the seed is forcibly pitted from the prune 12 by the pitting device and a part of the skin is pressed into the prune 12 then, so that the two overlapping skins of the front and back sides become four overlapping skins. The multiple overlapping skins are imaged as a dark wave (shade) or a shadow close to a fragment of a small seed.

In this way, since the surface of the pitted prune 12 has a number of wrinkles, it is difficult to discriminate between wrinkles and a remaining seed fragment. Thus, wrinkles are detected as a seed fragment and a malfunction is prone to occur.

In the image processing of the controller 88, a seed fragment existing in the prune 12 is distinguished from wrinkles. Thus, the prune 12 including a seed fragment can be removed as an NG prune and the prunes 12 with wrinkles can be collected as OK products.

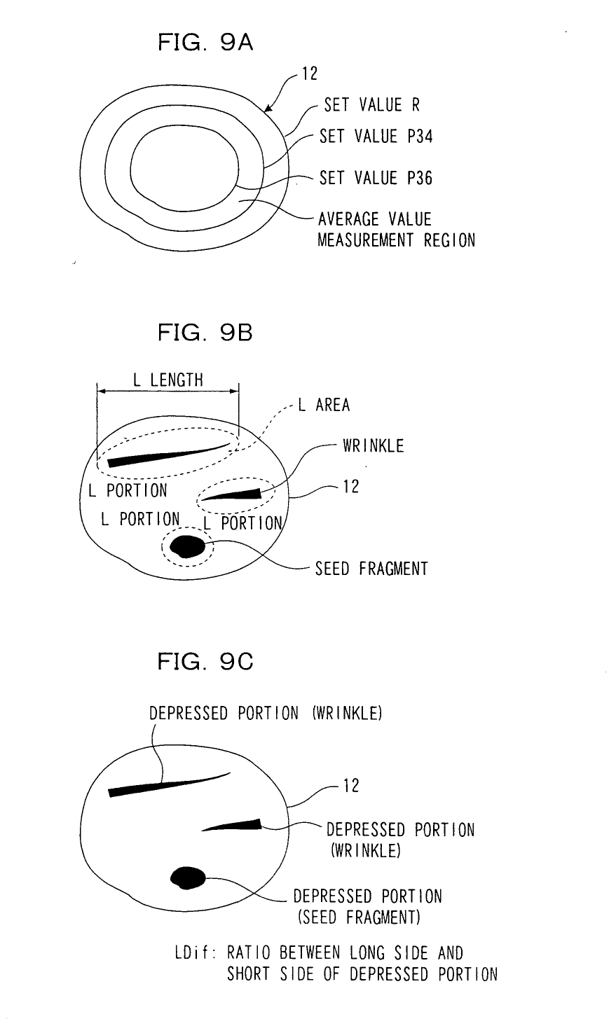

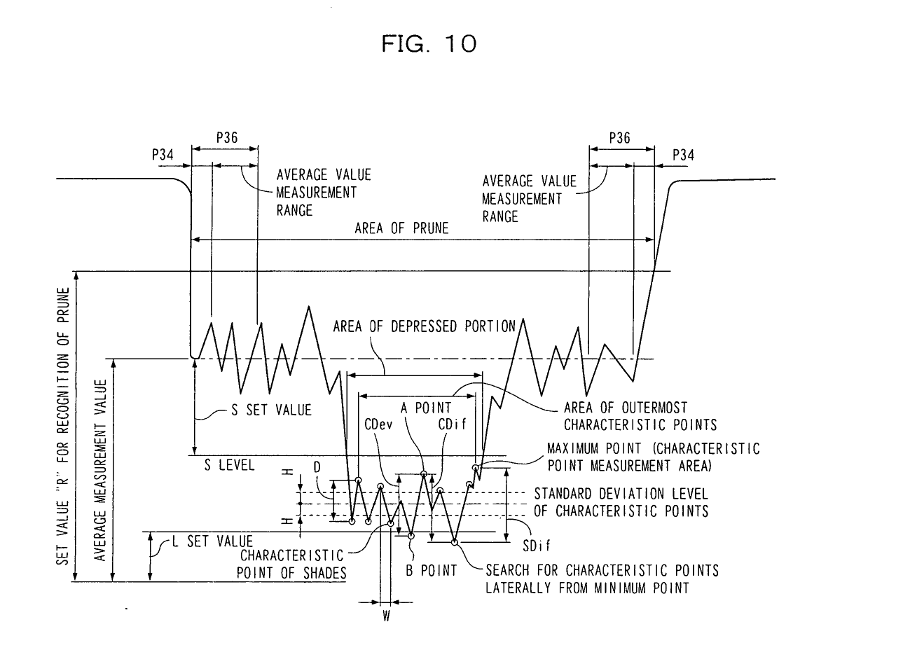

Referring to FIGS. 9A to 9C and 10, the following will first discuss measurement items and set values required for image processing.

FIGS. 9A, 9B and 9C each illustrates a surface of the prune 12. FIG. 10 shows a brightness level of a transmission light beam captured by the cameras 51 and 54 in a near-infrared environment.

In FIG. 9A, a set value R is a predetermined brightness level which is set beforehand to identify (recognize) a region of the prune 12 based on the photographing data of the cameras 51 and 54, that is, the brightness level of the measured prune 12. A region at the set value R or lower is determined as a region of the prune 12.

Further, FIG. 9A shows a set value which is set for measuring an average value (an example of an average brightness level) of brightness (shade) of wrinkles on the surface of an edge identified with no seed (a seed is positioned at the center of the prune 12 in most cases). A set value P-34 represents the number of dots set for an outer frame from the outer edge that is used for measuring an average value. A set value P-36 represents the number of dots set for an inner frame that is used for measuring an average value. A ring region surrounded by the parameters P-34 and P-36 is an average value measurement region (measurement range) of shades in FIG. 10. Contrasts on points (dots) in the average value measurement region are converted into numbers, the numbers are summed, and the result is divided by the number of dots, so that an average brightness (shade) of wrinkles on the surface (edge) of the prune 12 is measured (hereinafter referred to as a measurement average value).

The minimum area of the prune 12 to be inspected is set as a set value P-1. The set value P-1 is set to prevent an inspection when the area of the prune 12 is too small.

In FIG. 9B, regions surrounded by broken lines (L portions) indicate dark regions judged to have a probability of including a large seed fragment. The regions surrounded by the broken lines are identified when the brightness level of the measured prune 12 is less than L level (Low level; a set value at a low level based on the darkest part (0 level)). An area (L area) and a length (L length; a length in the conveying direction) of the L portion are measured. Although the set value of the L level corresponds to the depressed portion of a large seed and the like, a seed fragment and a wrinkle are not distinguished from each other in the L portion.

Regions filled with black in FIG. 9C may have seed fragments and represent depressed portions for forming conditions of discriminating a seed fragment and a wrinkle. The depressed portions are determined (identified) when the measured prune 12 has a brightness level equal to or lower than the level of the predetermined value S of FIG. 10 based on the measurement average value. An area of the depressed portion and the lengths of a long side and a short side of the depressed portion are measured. The depressed portion is a wrinkle or a seed fragment. Further, a ratio LDif of a long side and a short side of the depressed portion is determined. The ratio LDif is used to distinguish the shapes of a wrinkle and a seed fragment (squareness ratio).

Moreover, characteristic points in the depressed portion are determined. As shown in FIG. 10, the characteristic points are measured based on an inclination level of a wave (shade) in the depressed portion. That is, the standard deviation of the wave (shade) in the depressed portion is first determined. When the shade of the wave has an interval W and a contrast of D, the following point is measured as a characteristic point: the shade interval W is equal to or lower than a set value, the contrast D is equal to or higher than a set value, and a peak value is not included in an unmeasured range (2H; band width) above and below the standard deviation of the shade of the depressed portion.

Subsequently, an area surrounded by the outermost characteristic points of the characteristic points is measured. A ratio between the area of the depressed portion and the area surrounded by the outermost characteristic points is measured. A seed fragment is identified when the measured value SPct (=the area of the depressed portion/the area surrounded by the outermost characteristic points)>a set value is satisfied (because a seed fragment is more uniform than a wrinkle). Further, a difference SDif (Size difference) between the maximum value and the minimum value of the characteristic points in the depressed portion area is measured. On the condition of a measured value SDif>a set value, a seed fragment is identified (because a seed value is large in contrast than a wrinkle).

Moreover, a difference CDif is measured between the maximum value (A point) and the minimum value of the characteristic points passing through the unmeasured range. On the condition of a measured value CDif>a set value, a seed fragment is identified (the maximum point does not pass through the unmeasured range in FIG. 10). Besides, a value CDev is measured which is obtained by adding the number of lines passing through the unmeasured range to the difference between the maximum value (A point) and the minimum value of the characteristic points passing through the unmeasured range. On the condition of a measured value CDev>a set value, a seed fragment is identified. B point is disposed on the lower end of an inclined line having A point. Based on CDif and CDev, a small wave of a shade (a contrast of brightness) in the depressed portion is measured to identify a seed fragment.

Further, Wave is measured which indicates the number of characteristic points passing through the unmeasured range per area of the depressed portion. That is, the number of waves is measured per unit area at a height 2H or higher in the depressed portion (the number of shades on the surface of the depressed portion). On the condition of a lower limit set value<a measured value<an upper limit set value, a seed fragment is identified (because a seed fragment has more shade points).

In FIG. 10, reference character R denotes a set value (a set value based on the darkest portion (0 level)) for identifying (recognizing) the region of the prune (fruit) 12. The region of the prune 12 (the region of the fruit) is identified (recognized) by an overall reduction in light quantity, and the area and length of the prune 12 are measured.

Then, these items are measured and the set values are used to make the following decisions:
(1) The region of the prune 12 is identified (recognized) by the set value R and the area and the length (measured by the number of dots from photographing data) of the prune 12 are determined. When the prune 12 has an area smaller than the set value P-1 (set as the minimum area), the prune 12 is not inspected. Hence, when the area of the prune 12 is too small, an inspection is not performed. Further, a contrast on a point (dot) in the region surrounded by the set values P-34 and P-36 (average value measurement region) is converted into a number. The numbers are summed up and are divided by the number of dots to determined the average measurement value.

(2) The L portion is recognized based on the L level to determine the L area and L length, which are compared with the upper and lower limit set values corresponding to a predetermined size, so that a seed fragment of the predetermined size is detected.
L area setting; lower limit set value<measured value<upper limit set value
L length setting; lower limit set value<measured value<upper limit set value

(3) A depressed portion equal to or lower than the S level is determined based on the average measurement value, the area of the depressed portion and the lengths of a long side and a short side of the depressed portion are measured, the standard deviation level of the depressed portion is measured, and the characteristic points are determined. Subsequently, the following values are measured: the ratio LDif of the long side and the short side of the depressed portion, the radio SPct of the area of the depressed portion and the area of the outermost characteristic points, a difference SDif between the maximum value and the minimum value of the depressed portion, the difference CDif between the maximum value and the minimum value of the characteristic points passing through the unmeasured range of the depressed portion, the value CDev obtained by adding the number of points passing through the unmeasured range of the depressed portion to a difference between the maximum value of the characteristic points passing through the unmeasured range and the lower end value on the same inclined line, and the Wave which is the number of characteristic points passing through the unmeasured range of the depressed portion.

The conditions of a seed are set as below. When measured values satisfy all the following conditions, a depressed portion is judged to be a seed fragment.

The area of the depressed portion: a seed area at the L level or lower, a lower limit set value<a measured value<an upper limit set value

The length of the depressed portion: a seed length at the L level or lower, a lower limit set value<a measured value<an upper limit set value
LDif: a set value<a measured value
SPct: a set value<a measured value
SDif: a set value<a measured value
CDif: a set value<a measured value
CDev: a set value<a measured value
Wave: a lower limit set value<a measured value<an upper limit set value

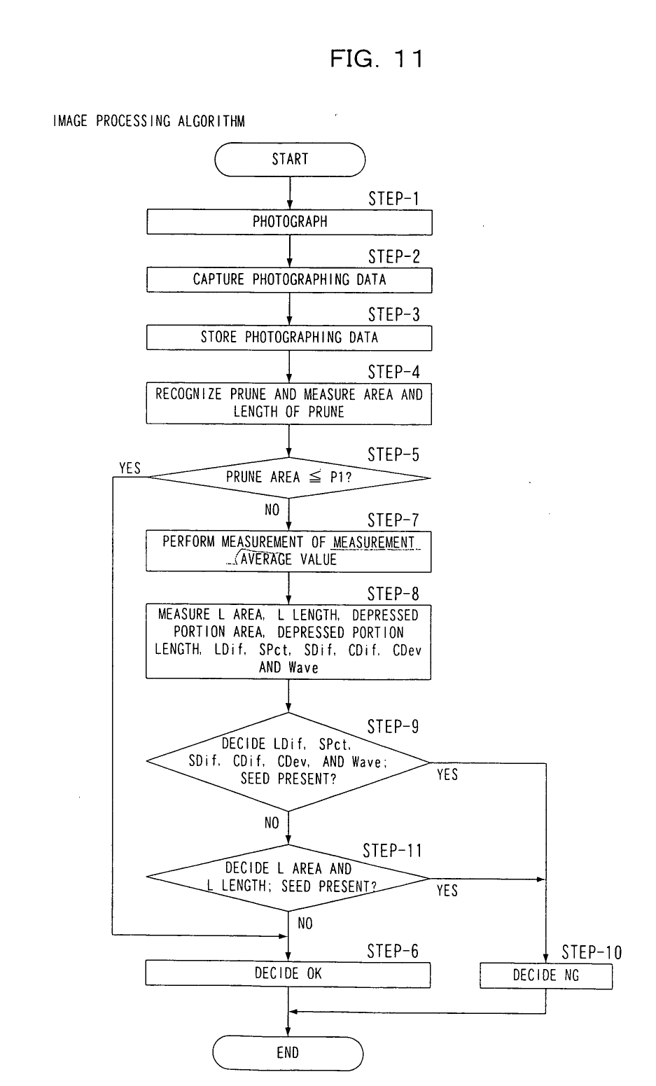

Referring to the flowchart of FIG. 11, the steps of actual image processing performed by the controller 88 will be described below. The image processing is performed on each of the prunes 12 in the lines based on the photographing data of the six infrared CCD cameras 51 and 54 in the upper part and the lower part.

First, when the prune 12 is photographed (step-1), the photographing data thereof is captured (step-2), and the photographing data is stored (step-3).

Then, the region of the prune 12 is identified (recognized) based on the set value R, the area and length of the prune 12 are measured (step-4), and the decision (1) is performed. That is, it is confirmed whether the prune 12 has an area smaller than or equal to the set value P-1 (step-5). When the area is smaller than or equal to the set value P-1, (without measurements) OK (no seed) is decided (step-6) and the processing is completed.

When the area of the prune 12 is larger than the set value P-1, the average measurement value is subsequently measured. As described above, the average measurement value is measured by converting contrasts on points (dots) in the region surrounded by the set values P-34 and P-36 (average value measurement region) into numbers, summing up the numbers, and dividing the result by the number of dots (step-7).

Subsequently, the measurement items, that is, the L area, the L length, the area of the depressed portion, the lengths of the long side and the short side of the depressed portion, the standard deviation level of the depressed portion, the characteristic points, LDif, SPct, SDif, CDif, CDev, and Wave are measured (step-8).

Then, the decision (3) is performed. That is, the following decision is performed to decide whether a seed fragment is present or not (step-9).
a lower limit set value<a depressed portion area measured value<an upper limit set value
a lower limit set value<a depressed portion length measured value<an upper limit set value
a set value<an LDif measured value
a set value<an SPct measured value
a set value<an SDif measured value
a set value<a CDif measured value
a set value<a CDev measured value
a lower limit set value<a Wave measured value<an upper limit set value

When all the conditions are satisfied, it is decided that a seed fragment is present and NG (defective; to be removed) is decided (step-10).

Then, in the decision (3), when it is decided that a wrinkle is present (no seed), the decision (2) is subsequently performed. That is, the following decision is performed on the L area and the L length to decide whether a seed of the predetermined size is present or not (step-11).
a lower limit set value<an L area measured value<an upper limit set value
a lower limit set value<an L length measured value<an upper limit set value

When these conditions are satisfied, it is decided a seed is present, and NG is decided in step-10. When these conditions are not satisfied, OK (no seed) is decided in step-6 and the processing is completed.

In this way, the image processing is performed on the backside and front side of the prune 12 passing through the infrared CCD cameras 51 and 54, and a discrimination is made between a seed fragment and a wrinkle. When a seed fragment is present, NG is decided.

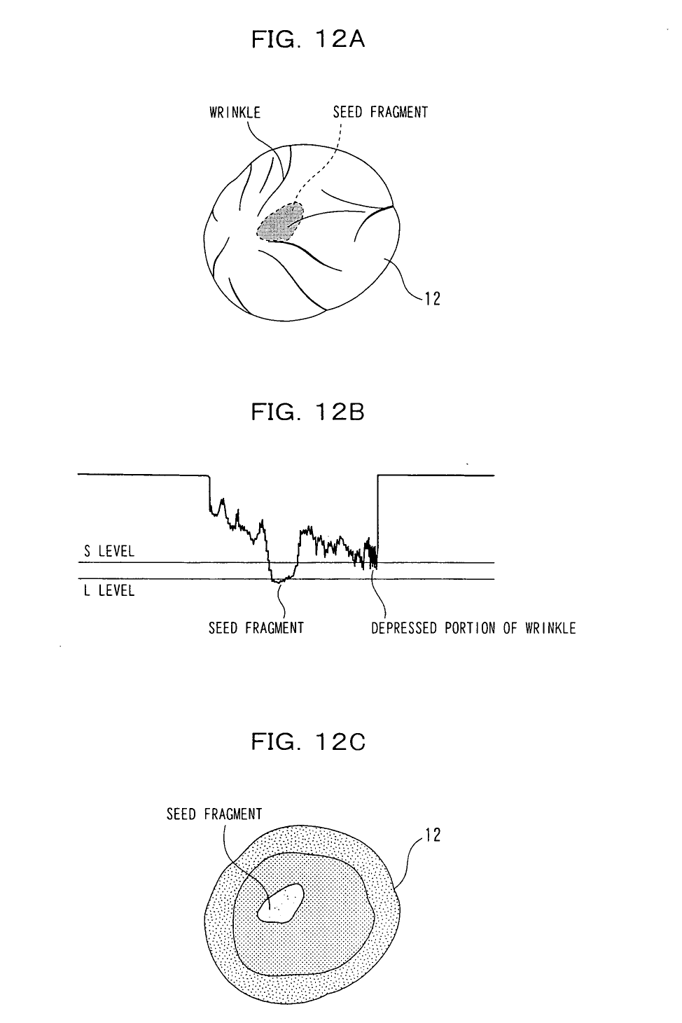

FIGS. 12A, 12B and 12C each illustrates an image displayed on the touch panel 83 by the controller 88 based on the image processing. FIG. 12A is an overall view of the prune 12 (photographed image). FIG. 12B is a characteristic diagram showing the photographing data of the prune 12 (corresponds to FIG. 10). FIG. 12C is an image diagram showing a portion judged to be a seed fragment after being processed based on the photographing data of the prune 12. When NG is decided, the data can be confirmed on a screen by the touch panel 83.

[Operation]

The operation of this configuration will be described below. It is assumed that the set values of the measurement items are set beforehand in the controller 88 by using the touch panel 83. Further, it is assumed that the driving motor 18 for the leveling conveyor 16 of the supply section 1, the driving motor 20 of the leveling roller 19, the driving motors 28 for the rolling device 23 of the rolling section 2, and the driving motor 66 for the belt conveyor 41 of the inspection/image processing/selection section 3 are driven by operating the device operation buttons 82 of the operation/control/power section 4, so that the leveling conveyor 16, the leveling roller 19, the rollers 24 and 25 of the rolling device 23, and the belt conveyor 41 are driven. Further, it is assumed that operation start is inputted to the controller 88 by means of the device operation buttons 82, the near-infrared LED illuminators 53 and 56 are driven by the controller 88 in response to the input, and driving signals are outputted to the six infrared CCD cameras 51 in the lower stage and the six infrared CCD cameras 54 in the upper stage, so that an inspection state is made. Moreover, it is assumed that water is sprayed from the spray nozzle 22. Besides, it is assumed that air is supplied to the solenoid valves 70.

When the prunes 12 are conveyed from the external conveyer 11, the prunes 12 are dropped into the leveling conveyor 16 from the hopper 13. Then, the overlapping prunes 12 are struck and scraped (leveled) by the rotary vanes 17 of the leveling roller 19 while being conveyed by the conveyor 15 of the leveling conveyor 16. The prunes 12 are stored respectively in the squares 14 of the conveyor 15, are aligned in nine lines, and are dropped into the rolling device 23.

In the rolling device 23, the prunes 12 are dropped into the upper rollers 24 while being arranged by the dividing guide plate 21. At this point, moisture is supplied to the surfaces of the rollers 24 and 25 and the scrapers 30 and 31 by spraying water from the spray nozzle 22. Thus, it is possible to prevent the stickiness of pulp from changing an interval and prevent pulp from filling in grooves on the surfaces of the rollers. Further, moisture is properly supplied to the surfaces of the rollers 24 and 25 and the prunes 12 (for example, an amount of water is about 28%) and thus the prunes 12 are readily exfoliated.

The prunes 12 are rolled with an even thickness through the upper rollers 24 and the lower rollers 25 in this order so as to form the conditions of transmitting near-infrared light, the visible outlines of wrinkles of the prunes 12 are cut, and the prunes 12 are dropped onto the belt conveyor 41. The prunes 12 and sticky materials (pulps) which have adhered to the upper rollers 24 and the lower rollers 25 are scraped off by the scrapers 30 and 31.

The prunes 12 having dropped onto the belt conveyor 41 are aligned in six lines by the aligning guide 42 (guides 58 and 59) while being conveyed by the transparent belt 41a. The image processing is performed when the prunes 12 in each line pass between the six infrared CCD cameras 51 in the lower stage and the six infrared CCD cameras 54 in the upper stage. Then, when NG (defective; to be removed) is decided, pulses outputted from the rotary encoder 67 are counted from the positions of the six infrared CCD cameras 51 in the lower stage or the positions of the six infrared CCD cameras 54 in the upper stage, so that a driving signal (a driving signal to the solenoid valves 70) is outputted when the prune 12 judged to be NG arrives at the position of the air guns 69, and the prune 12 is removed to the NG box 71. The prunes 12 judged to be normal are directly conveyed to downstream operations. Further, the pulp of the prunes 12 adhering to the transparent belt 41a is scraped and washed out in the cleaning chamber 49 which is disposed on the return side of the transparent belt 41a, and thus a clean state is maintained all the time.

As described above, according to the present embodiment, the depressed portion which is a region at S level or lower is determined based on the average measurement value on the edge surface of the prune 12. Only wrinkles are present on the edge surface. Thus, it is possible to identify a region which may have a seed fragment and it is possible to decide whether the depressed portion is a seed fragment or a wrinkle based on the shape (a characteristic of a measurable brightness level (shade) property) of the depressed portion (it is possible to distinguish between a wrinkle on the surface of the prune 12 and a seed fragment). Hence, it is possible to prevent a number of comforting articles from being removed and lost by mistaking wrinkles for seed fragments, thereby obtaining high-quality pitted prunes 12 with high yields. Further, it is possible to positively remove the prunes 12 including seed fragments, achieving high quality. In this case, a distinction is made between a wrinkle on the surface of the prune 12 and a seed fragment based on measured values including an area of the depressed portion, a length of the depressed portion, a ratio LDif of a long side and a short side of the depressed portion, a ratio SPct of an area of the depressed portion and an area surrounded by the outermost characteristic points, a difference SDif between the maximum value and the minimum value of the characteristic points of the depressed portion, a difference CDif between the maximum value and the minimum value of the characteristic points passing through the unmeasured range of the depressed portion, a value CDev obtained by adding the number of points passing through the unmeasured range to a difference between the maximum value of the characteristic points passing through the unmeasured range of the depressed portion and the lower end value of the same inclined line, and a Wave which is the number of the characteristic points passing through the unmeasured range of the depressed portion.

According to the present embodiment, as conditions for automatically inspecting a large number of seed fragments of the prunes 12, the transmitting conditions of an evenly transmission light beam are formed with an even thickness by the rolling device 23 and the visible outline of a wrinkle is cut to distinguish between a wrinkle and a seed fragment (a continuous line is cut), so that the quality of the prune 12 can be stably decided with high accuracy. Further, moisture is applied to the rolling rollers 24 and 25 and the scrapers 30 and 31 by spraying water from the spray nozzle 22. Thus, it is possible to prevent the pulp of the prunes 12 (sticky materials) from changing an interval between the rolling rollers 24 and 25 and prevent the pulp from filling in grooves on the surfaces of the rollers. Further, moisture is properly supplied to the prunes 12.

Moreover, as conditions for automatically inspecting a large number of seed fragments of the prunes 12, the overlapping of the prunes 12 is eliminated by the leveling roller 19. The prunes 12 are aligned without overlapping and are conveyed to the rolling rollers 24 and 25 by the leveling conveyor 16. Thus, the thicknesses of the prunes 12 can be made uniform by the rolling rollers 24 and 25, so that the quality of the prunes 12 can be stably decided with high accuracy.

According to the present embodiment, as conditions for automatically inspecting a large number of seed fragments of the prunes 12, the prunes 12 are aligned and conveyed by the aligning guide 42 so as to correspond to the infrared CCD cameras 51 and 54. Thus, it is possible to positively capture an image of the prune 12 immediately under the infrared CCD cameras 51 and 54 and to stably decide the quality of the prunes 12 with high accuracy.

According to the present embodiment, as conditions for automatically inspecting a large number of seed fragments of the prunes 12, the pulp of the prunes 12 adhering to the transparent belt 41a is scraped and washed out in the cleaning chamber 49 and a clean state is maintained all the time. Thus, it is possible to stabilize the images of the infrared CCD cameras 51 and 54, thereby preventing comforting articles from being mistaken for defectives due to the pulp of the prunes 12 adhering to the transparent belt 41a.

In the present embodiment, near-infrared light is used as a transmission light beam which passes through the prunes 12 (an example of a fruit). Any light beam can be used as long as the light beam passes through the prunes 12. For example, ultraviolet radiation and visible radiation are applicable.

Further, in the present embodiment, the decision (2) is made, that is, a decision is made based on an L area and an L length. However, the decision (2) is not necessarily performed. In many cases, the presence or absence of a seed fragment can be decided by the decision (3) described above.

1. A seed fragment inspection apparatus, comprising:
a transparent belt conveyor for conveying a pitted fruit;
illuminators opposed to each other across a transparent belt of the transparent belt conveyor and emitting a transmission light beam to a fruit conveyed by the transparent belt conveyor, the light beam passing through the fruit;
a camera device for photographing an image of the transmission light beam having been emitted from the illuminators and passed through the fruit; and
a controller for determining a region at not higher than a predetermined brightness level (R) as a fruit region based on photographing data of the camera device, determining an average brightness level of an edge surface of the fruit region, determining a region at not higher than a predetermined level (S) as a region of a depressed portion based on the determined average brightness level, and deciding whether or not a seed fragment remains in the fruit based on a shape of the determined depressed portion.

2. The seed fragment inspection apparatus according to claim 1, wherein the controller decides whether or not a seed fragment remains based on the shape of the depressed portion by determining an area of the depressed portion, a length of the depressed portion, a ratio between a long side and a short side of the depressed portion, a ratio between an area of the depressed portion and an area surrounded by an outermost periphery of a characteristic point measured based on an inclination level of a shade in the depressed portion, a difference between a maximum value and a minimum value of the characteristic point in the depressed portion, a difference between the maximum value and the minimum value of the characteristic point passing through an unmeasured range of the depressed portion, a value obtained by adding the number of characteristic points passing through the unmeasured range to a difference between the maximum value of the characteristic point passing through the unmeasured range of the depressed portion and a lower end value of a same inclined line as the maximum value, and the number of the characteristic points passing through the unmeasured range of the depressed portion.

3. The seed fragment inspection apparatus according to claim 1, wherein the illuminator and the camera device comprise two pairs of illuminators and camera devices for respectively photographing an image of a front side and an image of a backside of the fruit.

4. The seed fragment inspection apparatus according to claim 1, further comprising a rolling device comprising a pressure roller for rolling the fruit supplied to the transparent belt conveyor to be of a predetermine thickness allowing a transmission light beam to pass through the fruit, and cutting a contour line of a wrinkle on the fruit.

5. The seed fragment inspection apparatus according to claim 4, wherein the rolling device comprises a scraper for scraping off an adhered fruit pulp from a surface of the pressure roller and a spray device for spraying water to the scraper and the pressure roller.

6. The seed fragment inspection apparatus according to claim 1, further comprising a leveling roller for removing a sticky material of fruit pulp appearing when a seed is extracted, and a leveling conveyor for aligning and supplying the fruits onto the pressure roller of the rolling device so that each fruit is free from being placed on top of another.

7. The seed fragment inspection apparatus according to claim 1, wherein the transparent belt conveyor comprises an aligning guide for arranging and conveying the fruits in an aligned manner with respect to the camera device.

8. The seed fragment inspection apparatus according to claim 7, wherein the aligning guide is divided into a plurality of guides in a first stage upstream from the transparent belt conveyor and a plurality of guides in a second stage extending to a close vicinity of the camera device.

9. The seed fragment inspection apparatus according to claim 1, further comprising a cleaning chamber for scraping and washing away a pulp of the fruit adhering to the transparent belt of the transparent belt conveyor.

10. The seed fragment inspection apparatus according to claim 1, further comprising a selection device disposed downstream from the transparent belt conveyor, for extracting a fruit when the controller detects a seed fragment in the fruit.
